(19) United States
(12) Patent Application Publication
(10) Pub. No.: US 2005/0210754 A1
(43) Pub. Date: Sep. 29, 2005

(54) Adjustable threshold assembly

(75) Inventor: Robert W. Ferrell, Richmond, IN (US)

Correspondence Address: Alan F. Meckstroth;JACOX, MECKSTROTH & JENKINS, Suite 2, 2310 Far Hills Building, Dayton, OH, 45419-1575, US

(73) Assignee: Imperial Products, Inc.

(21) Appl. No.: 10/800,317

(22) Filed: Mar. 15, 2004

(51) Int. Cl. E06B 1/70

(52) U.S. Cl. 49/468

(57) ABSTRACT

An elongated threshold extends under a swinging door and defines an upwardly facing and longitudinally extending cavity which receives a vertically adjustable rail member. The rail member has longitudinally spaced pre-assembled adjustment screw units each of which includes a tubular bushing having a press-fit connection with the rail member. Each bushing supports the shank portion of rotatable screw having a head portion with a recess for receiving an adjustment tool. Each screw is retained within its corresponding bushing by a washer having a press-fit on the screw which threads into an inverted T-nut seated within a slot within the threshold.

### BACKGROUND OF THE INVENTION

The present invention relates to an adjustable threshold assembly of the general type disclosed in U.S. Pat. No. 5,517,788 and No. 5,524,391 which issued to the assignee of the present invention and the disclosures of which are herein incorporated by reference. As disclosed in these patents, a threshold incorporates a vertically adjustable elongated rail member which extends under the bottom surface of a swinging door, and the rail member is adjusted vertically after the threshold assembly has been installed with a door frame to provide an effective seal with a flexible or deformable sealing strip mounted on the bottom edge of the door.

As also disclosed in the above mentioned patents, the rail member supports a plurality of longitudinally spaced rotatable head portions of adjustments screw assemblies, and the head portions have Phillip recesses for receiving an adjustment screw driver. Each of the head portions has a bore which receives an upper splined end portion of an adjustment screw having a shoulder which carries a flat annular washer. The upper splined end portion of each screw is press-fitted into the head portion of the adjustment screw after the head portion is inserted in the rail member so that the adjustment screw is held captive for rotation within the rail member. The lower threaded end portion of each adjustment screw is received within a corresponding inverted T-nut which is inserted laterally into a corresponding slot within a base portion of the threshold assembly.

The adjustment screw assemblies disclosed in the above patents comprise specially machined parts which are expensive to produce, and substantial time is required to assemble the parts or components manually on the threshold and rail member.

### SUMMARY OF THE INVENTION

The present invention is directed to an improved adjustable threshold assembly which is more economically and efficiently produced by significantly reducing the cost of the components for adjusting the rail member and for simplifying the assembly of the adjusting components on the rail member. In accordance with one embodiment of the invention, an elongated rail member is adjusted vertically by a plurality of longitudinally spaced adjustment screw units each of which includes a tubular bushing which is press-fitted into a hole within the rail member from the bottom of the rail member and rotably supports the upper portion of a standard machine screw. The screw has a head portion with a recess for receiving an adjustment screw driver, and a retaining washer is press-fitted onto the screw shank portion and is located adjacent the bottom the bushing and a bottom surface of the rail member. A lower threaded end portion of the screw receives a conventional metal T-nut having an elongated base portion which seats within a slot within the threshold. The screw, bushing and nut may be pre-assembled by automated equipment, and each pre-assembly is then press-fitted into the rail member.

Other features and advantages of the invention will be apparent from the following description, the accompanying drawing and the appended claims.

### BRIEF DESCRIPTION OF THE DRAWING

FIG. 1 is a vertical cross-section through a lower door portion and a threshold assembly having an adjustable rail member supported by adjustment screw units constructed in accordance with the invention;

FIG. 2 is an enlarged fragmentary section of the threshold assembly showed in FIG. 1; and

FIG. 3 is an exploded perspective view of an adjustment screw unit or pre-assembly as shown in partial section in FIGS. 1 and 2.

### DESCRIPTION OF THE PREFERRED EMBODIMENT

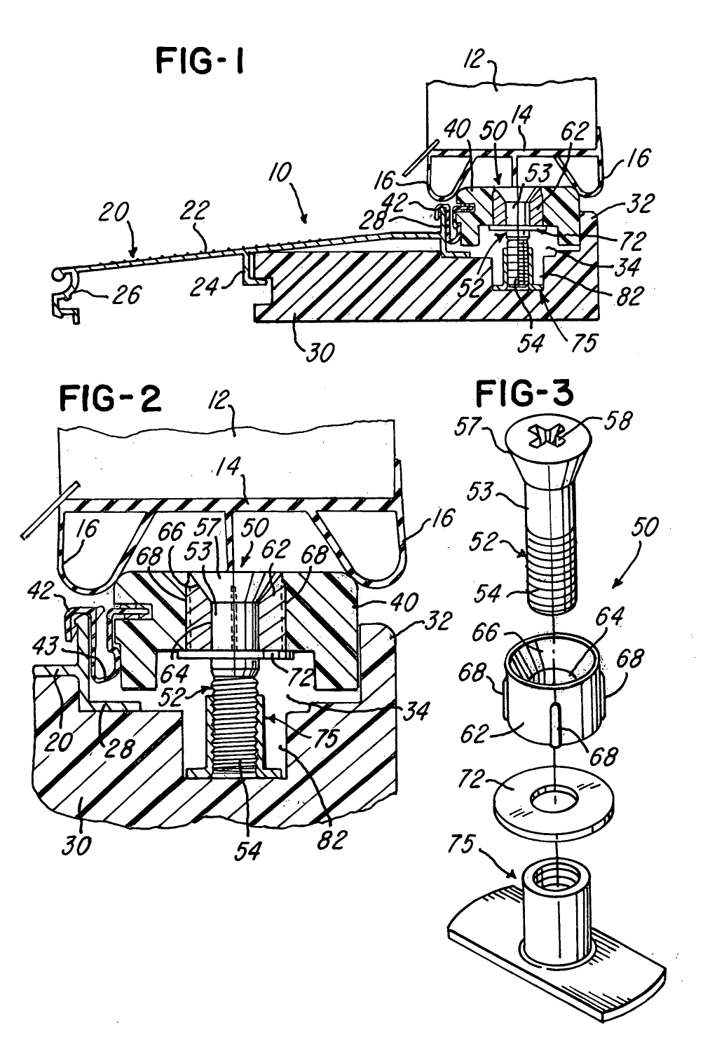

FIG. 1 illustrates a threshold or threshold assembly 10 which is constructed similar to the threshold assembly disclosed in the above-mentioned patents and which extends at the bottom of a rectangular frame (not shown) supporting a movable or swinging door 12. The door has a bottom surface which carries weather stripping sweep or a sealing strip 14 which is preferably extruded of a plastics or rubber material and has resilient and flexible downwardly projecting edge portions 16. The threshold assembly 10 includes an extruded aluminum sill member 20 which has a generally flat and sloping top wall 22, a downwardly projecting L-shaped intermediate flange 24 and an outer flange 26 which may also be used for attaching an extruded aluminum sill extension strip or member (not shown). The aluminum sill member 20 also includes an L-shaped flange or end portion 28 which seats on a base member 30 formed of wood or a plastics material or a composite material, and the base member hooks onto the flange 24.

The base member 30 has an upwardly projecting inner flange or lip portion 32 which cooperates with the L-shaped end portion 28 of the sill member 20 to define a longitudinally extending cavity 34. While one form of threshold 10 is illustrated in FIG. 1, it is to be understood that the threshold may be constructed in other forms such as one-piece extrusion or pultrusion of reinforced plastics material or as threshold of a blow molded plastics material. In any such form, the threshold may have an aluminum layer or extrusion to form the top sloping wall surface 22.

As shown in FIGS. 1 and 2, an elongated adjustable rail member 40 extends within the cavity 34 and may be formed of various materials such as wood or as an extrusion of plastics material or of a composite material. A continuous flexible sealing strip 42 is extruded of a plastics or vinyl material and connects the top of the L-shaped flange 28 to the rail member 40. The sealing strip 42 has a flexible U-shaped portion 43 and provides a continuous fluid-tight seal between the sill member 20 and the vertically adjustable rail member 40, in the same manner as disclosed in U.S. Pat. No. 5,230,181 which issued to the assignee of the present invention.

In accordance with the present invention, the rail member 40 is adjusted vertically after the threshold 10 is installed in order for the top surface of the rail member to be precisely positioned with respect to the door sealing strip 14. This vertical adjustment is produced by a series of longitudinally spaced adjustment screw units 50 which may be preassembled prior to insertion into the rail member 40. One form of adjustment screw unit 50 is shown in FIG. 3 and includes a conventional machine screw 52 having a cylindrical shank portion 53, a lower threaded portion 54 and a flat top tapered head portion 57 having a recess 58 for receiving a Philips-type screwdriver bit.

An annular bushing 62 may be formed of metal and has a cylindrical bore 64 which supports the shank portion 53 of the screw 52 for free rotation of the screw. The bushing 62 also has a tapered or frusto-conical top surface 66 which mates with the tapered surface 57 of the screw 52, and the outer surface of the bushing 62 has a plurality of four circumferentially spaced and axially extending outwardly projecting ribs 68. After the bushing 62 is assembled onto the screw 52, a spring retaining washer 72, such as sold under the trademark TINNERMAN, is press-fitted onto the shank portion 53 of the screw 52 so that the bushing 62 is captured on the rotatable screw 52. The adjustment screw unit 50 also includes a metal T-nut 75, such as sold under the trademark TINNERMAN, and which is threaded onto the threaded portion 54 of the screw 52.

After a series of the adjustment screw units 50 have been pre-assembled, which may be performed by automatically operated equipment, the assemblies or units 50 are quickly assembled into the rail member 40 by simply pressing the bushing 62 of each unit upwardly into the rail member 40 until the top of the screw 52 is flush with the top surface of the rail member 40, and the washer 72 engages the bottom surface of the rail member, as shown in FIG. 2. After the adjustment screw units 50 are inserted into the rail member 40, the rail member and adjustment screw units 50 are lowered into the cavity 34, and the T-nuts 75 seat within the bottom of a longitudinally extending slot 82 formed within the base portion on member 30 of the threshold 10. If desired, the T-nuts may be press-fitted into the slot 82 during assembly of the rail member so that the T-nuts are positively retained by the threshold base member 30.

It is apparent from the drawing and the above description that a threshold assembly including the adjustment screw units 50 provide for an economical and efficient system for vertically adjusting the rail member 40. For example, the use of a standard screw 52, a standard washer 72 and a standard T-nut 75, minimalizes the cost of the adjustment screw units 50, and these parts may be pre-assembled with the bushing 62. In addition, after the adjustment screw units 50 are pre-assembled, they may be quickly assembled into the rail member 40 simply by pressing the bushings 62 into the mating bores or holes within the rail member. When each bushing 62 is pressed axially into the rail member, the ribs 68 on each bushing positively engage the rail member and prevent rotation of the bushing within the rail member as well as positively lock the bushings within the rail member. The rail member 40 and assembled screw units 50 may then be quickly assembled onto the threshold 10.

While the form of threshold assembly herein described constitutes a preferred embodiment of the invention, it is to be understood that the invention is not limited to this precise form of threshold, and that changes may be made therein without departing from the scope and spirit of the invention as defined in the appended claims.

1. A threshold assembly adapted to be installed below the bottom surface of a movable door, comprising an elongated threshold having a sloping top sill surface and a longitudinally extending cavity, an elongated rail member disposed within said cavity, a plurality of longitudinally spaced adjusting screw units connecting said rail member to said threshold, each of said screw units including a tubular bushing secured to said rail member and having a vertical axis, a screw extending into said bushing of each unit and having an upper portion captured for rotation within said bushing, said screw having a head portion with surfaces for receiving a tool to provide for rotating said screw within said bushing, and a nut member threadably receiving said screw and retained by said threshold against rotation relative to said threshold:

2. An assembly as defined in claim 1 wherein said bushing has a press-fit connection with said rail member.

3. An assembly as defined in claim 2 wherein each said bushing has peripherally spaced and outwardly projecting ribs having a press-fit connection with said rail member.

4. An assembly as defined in claim 1 and including a radially outwardly projecting flange on said screw and disposed under said bushing.

5. An assembly as defined in claim 4 wherein said flange comprises an annular washer having a press-fit connection with a cylindrical shank portion of said screw.

6. An assembly as defined in claim 5 wherein said tubular bushing and said washer are metal.

7. An assembly as defined in claim 1 wherein said head portion of said screw has a tapered outer surface, and said bushing has a tapered inner surface receiving said outer surface of said screw.

8. An assembly as defined in claim 1 wherein said bushing and said screw have top surfaces substantially flush with a top surface of said rail member.

9. A threshold assembly adapted to be installed below the bottom surface of a movable door, comprising an elongated threshold having a sloping top sill surface and a longitudinally extending cavity, an elongated rail member disposed within said cavity, a plurality of longitudinally spaced adjusting screw units connecting said rail member to said threshold, each of said screw units including a tubular bushing secured to said rail member and having a vertical axis, a screw extending into said bushing of each unit and having an upper portion captured for rotation within said bushing, said screw having a flat top head portion with a recess for receiving a tool to provide for rotating said screw within said bushing, a flange on said screw and projecting outwardly under said bushing, and an inverted T-nut threadably receiving said screw and retained by said threshold against rotation relative to said threshold.

10. An assembly as defined in claim 9 wherein said bushing has a press-fit connection with said rail member.

11. An assembly as defined in claim 10 wherein each said bushing has peripherally spaced and axially extending ribs having a press-fit connection with said rail member.

12. An assembly as defined in claim 9 wherein said flange projects radially outwardly under said rail member.

13. An assembly as defined in claim 12 wherein said flange comprises an annular washer having a press-fit connection with a cylindrical shank portion of said screw.

14. An assembly as defined in claim 13 wherein said tubular bushing and said washer are metal.

15. An assembly as defined in claim 9 wherein said head portion of said screw has a tapered outer surface, and said bushing has a tapered inner surface receiving said outer surface of said screw.

16. An assembly as defined in claim 9 wherein said bushing and said screw have top surfaces substantially flush with a top surface of said rail member.

17. An assembly as defined in claim 9 wherein said screw, bushing and T-nut form a pre-assembly.

18. In a threshold assembly including a rail member and adapted to be installed below the bottom surface of a movable door, an adjusting screw unit including a tubular bushing secured to said rail member and having a vertical axis, a screw extending into said bushing and having an upper portion captured for rotation within said bushing, said screw having a head portion with surfaces for receiving a tool to provide for rotating said screw within said bushing, and a nut member threadably receiving said screw.

19. An assembly as defined in claim 18 wherein said bushing has a press-fit connection with said rail member.

20. An assembly as defined in claim 18 and including a radially outwardly projecting flange on said screw and disposed under said bushing.
